(19) United States
(12) Patent Application Publication
(10) Pub. No.: US 2008/0298344 A1
(43) Pub. Date: Dec. 4, 2008

(54) Method and Apparatus to Facilitate Assessing and Using Security State Information Regarding a Wireless Communications Device

(75) Inventor: Ruihua Zhang, Naperville, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/757,131

(22) Filed: Jun. 1, 2007

(51) Int. Cl. H04L 12/66

(52) U.S. Cl. 370/352

(57) ABSTRACT

Upon determining (101) that a wireless communications device (501) seeks access to an Internet Protocol-based communications network (500), a security state as corresponds to the wireless communications device is accessed (104). A network controller (505) for the Internet Protocol-based communications network is then informed (105) as to whether the wireless communications device should be granted the aforementioned access to the Internet Protocol-based communication network as a function of that security state. To facilitate such steps, if desired, these teachings will further accommodate receiving (102) information as corresponds to at least one security state of the wireless communications device and storing (103) security state information as corresponds to that information in a security state data base (304).

### TECHNICAL FIELD

This invention relates generally to Internet Protocol-based communications networks and more particularly to the provision of corresponding services to a wireless communications device.

### BACKGROUND

Various communications networks are known in the art. These include networks capable of providing one or more communications services to one or more wireless communications devices (such as voice-only platforms, data-only platforms, voice and data platforms, and so forth). In some cases, such services are fully internal with respect to the network itself. In other cases, such services can comprise permitting and facilitating access to and between services and resources that are external to the network.

In either case, many such networks and wireless communications devices are increasingly comprised of software-based platforms and components. Furthermore, many such systems are built, partially or fully, upon a use of the Internet Protocol (IP) as a data-bearing vehicle. Such approaches are favored, at least in part, due to their growing ubiquity and hence corresponding growing compatibility and economically favorable scales of economy.

Unfortunately, these same design choices also carry risks and present various issues of concern. For example, it is becoming increasingly possible for a wireless communications device to harbor a transmissible security weakness. Examples include, but are not limited to, software viruses and worms, software bugs and defects, and so forth. Though at present little appreciated, such security weaknesses can present, in turn, a risk of infection, infestation, and/or corresponding operational impairment to the communications network itself.

### BRIEF DESCRIPTION OF THE DRAWINGS

The above needs are at least partially met through provision of the method and apparatus to facilitate assessing and using security state information regarding a wireless communications device described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a call flow diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon determining that a wireless communications device seeks access to an Internet Protocol-based communications network, a security state as corresponds to the wireless communications device is accessed. A network controller for the Internet Protocol-based communications network is then informed as to whether the wireless communications device should be granted the aforementioned access to the Internet Protocol-based communication network as a function of that security state. To facilitate such steps, if desired, these teachings will further accommodate receiving information as corresponds to at least one security state of the wireless communications device and storing security state information as corresponds to that information in a security state data base.

Such security state information can be acquired from any of a wide variety of sources. Examples include, but are not limited to, an intrusion detection system, an intrusion prevention system, a firewall, an application proxy server, a virus detection system, and so forth. By one approach such sources can be configured and arranged to provide security state information on a regular or irregular basis as desired. By another approach, alone or as used in conjunction with such a push strategy, such sources can be configured and arranged to provide such information upon receiving a corresponding request. Depending upon the configuration of a given applications setting, this may optionally include the intervening use of a management server to facilitate the transfer and/or exchange of such information.

In most if not all cases, such network components comprise partially or wholly programmable platforms. Such components are therefore readily configured and arranged to provide such security state information as desired via corresponding programming. As such programming is well within the skill set of the average practitioner, for the sake of brevity further elaboration will not be provided here regarding specific details of such programming as might be appropriate to meet the needs and requirements of a given specific application setting.

So configured, these teachings provide a considerable amount of security where previously little or no such comfort existed. Those skilled in the art will appreciate and understand that these teachings are readily scaled and will accommodate a wide variety of network configurations, wireless communication devices, and corresponding wireless services. These teachings will also support considerable flexibility with respect to the particular nature of a system response to a less-than-stellar security state for a given wireless communication device.

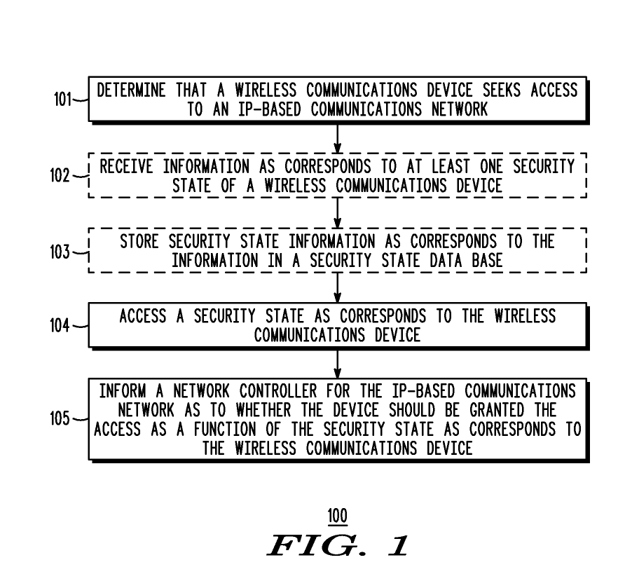

These and other benefits may become clearer upon making a thorough review and study of the following detailed description. Referring now to the drawings, and in particular to FIG. 1, an illustrative process 100 as corresponds generally with these teachings will be described.

Pursuant to this process 100, upon determining 101 that a wireless communications device seeks access to an Internet Protocol-based communications network, an implementing apparatus (such as, but not limited to, a security state server) can access 104 a security state as corresponds to the wireless communications device. Such a determination 101 can be based, for example and at least in part, upon receiving a security state check request from a network controller for the Internet Protocol-based communications network. Though such a request does not comprise a specific part of the current art, configuring and arranging such a network controller to make such a request is well within the skill and capabilities of the average artisan.

The aforementioned “security state” can vary in its particulars to accommodate a given application setting. Generally speaking, however, this expression will be understood to refer to transmissible software-based problems and in particular such problems as present a significant risk to the continuing viability and operability of the Internet Protocol-based communications network itself. Examples include, but are not limited to, a software virus, a software worm, a software Trojan horse, a software-based logic bomb, so-called malware (including but not limited to software designed to expose an infected computational platform to unauthorized external control), a serious software bug or defect that presents and/or exposes security weaknesses as may be detectable by a monitoring and/or reporting platform as described above, unpatched software, a non-standard software configuration, and so forth.

Those skilled in the art will recognize that various ways may exist by which this access to security state information can be effected. As one optional illustrative example in this regard, this can be facilitated, at least in part, by receiving 102 information as corresponds to the security state of the wireless communications device and then storing 103 security state information as corresponds to the information in a security state data base. Such information might be received 102, for example, from a network monitoring platform of choice. Illustrative examples in this regard might include, but are not limited to, an intrusion detection system, an intrusion detection and prevention system, a firewall, an application proxy server, a virus detection system, and so forth. Various approaches are known in the art in these regards. As these teachings are not overly sensitive to any particular selection in this regard, for the sake of brevity and the preservation of clarity, further elaboration in this regard will not be presented here except where appropriate to specific examples provided herein.

By one approach this information can be received 102 from time to time by, for example, a network monitoring platform that sources such information on a regularly scheduled basis (such as every so many minutes, hours, days, or the like). By another approach, in lieu of or in combination with the above, the network monitoring platform can be configured and arranged to source such information on an irregular, anecdotal basis (as when, for example, the information represents a change as compared to previous information for the wireless communications device).

By another approach, again in lieu of or in combination with the approaches described above, such information can be received 102 in response to having transmitted a corresponding request for such information. Again, such requests can be sourced on as regular or irregular a basis as may be deemed appropriate to the needs, requirements, and/or opportunities posed by a given application setting.

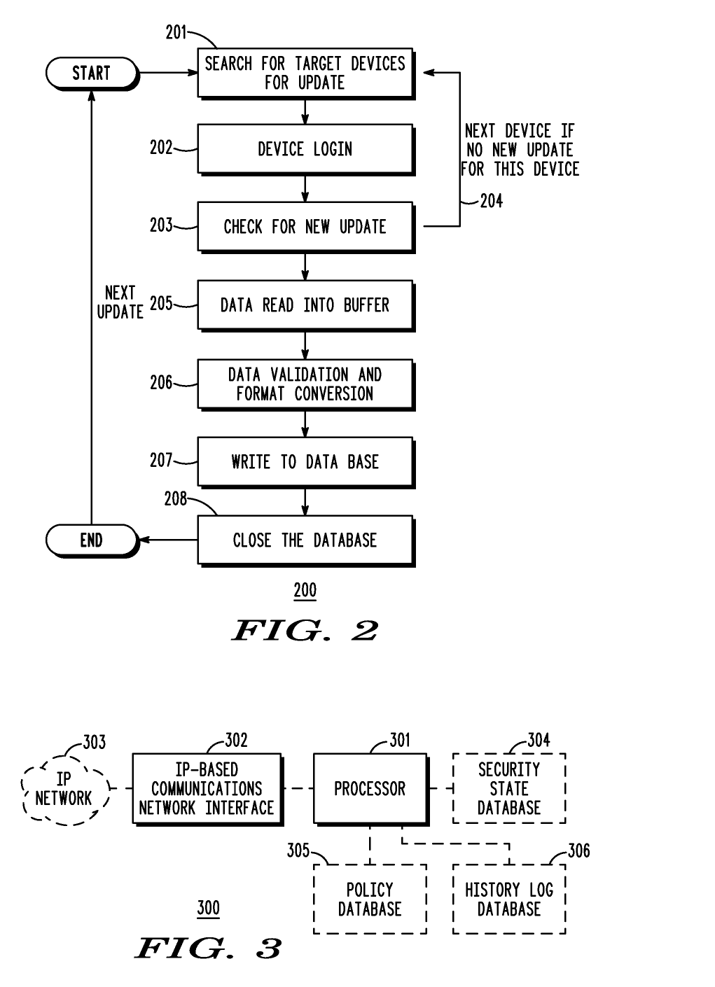

Referring momentarily to FIG. 2, an illustrative, non-limiting example in these regards will be described. Pursuant to this illustrative process 200, one can search 201 for target devices to update. This can be based, for example, upon a pre-provisioned list of wireless communications devices. It would also be possible to base this search upon a dynamic querying processes. In this regard, upon determining that a given device has logged in 202, this process 200 will provide for checking 203 at that time for a new security state update. These activities can then be repeated 204 as appropriate to accommodate a complete pool of monitored devices.

New information gleaned in this manner can be buffered 205, subjected to such data validation and format conversions 206 as may be appropriate to suit the needs or requirements of a given application setting, and then written 207 to a database of choice. Upon concluding these activities the database can be closed 208 and the process 200 concluded pending its next iteration.

Accordingly, it will be understood that the aforementioned step of assessing 104 the wireless communications device security state can comprise, at least in part, querying a security state data base to retrieve such security state information as correlates to the wireless communications device. These teachings will further accommodate, however, also querying a corresponding policy data base to thereby retrieve a policy (which may include retrieving multiple possibly-interrelated policies) as corresponds to the security state information. Such a policy data base can comprise a dynamically provisionable platform if desired. By one approach, for example, this can include providing a human user interface to thereby facilitate a mechanism whereby one or more of these policies can be provided to such a policy data base and/or otherwise operationally influenced or directed.

Such policies can provide instructions, for example, as to when a given security state is sufficiently worrisome to warrant denying the sought-after network access and when it may be acceptable to permit unrestricted access to the network notwithstanding a given security state condition of interest. This approach will readily accommodate other possibilities as well, however. For example, such a policy can provide guidance with respect to permitting only conditional access to the Internet Protocol-based communication network. If desired, one or more of these policies can be rendered subject to one or more other conditions, such as time, network loading, and so forth.

Illustrative examples of such conditional access might include time-limited access (for example, only permitting the wireless communications device to have the requested access for no more than a given specified amount of time), functionality-limited access (for example, only permitting the wireless communications device to utilize a limited set of functions when engaging in the requested network access), services-limited access (for example, only permitting the wireless communications device to utilize a limited set of network services, such as voice only services), destination-limited access (where, for example, the wireless communications device is only permitted to communicate with or otherwise interact with a limited set of communications targets), and the like.

This process 100 then provides for informing 105 a network controller (such as, for example, the network controller that made the corresponding inquiry about this wireless communications device's security state) for the Internet Protocol-based communications network as to whether the wireless communications device should be granted the aforementioned access to the Internet Protocol-based communication network. As noted above, this can comprise, if desired, determining such access as a function of the assessed security state as well of one or more policies as may correspond to the security state information for that wireless communications device.

In the described approach, the network controller is simply instructed as to how to handle the wireless communications device's request for access. Again, this can comprise advising the network controller to permit unrestricted access to the Internet Protocol-based communication network, to fully deny such access, or to permit partial access only (as when such access is conditioned upon, for example, limitations with respect to time, functionality, services, and/or communication target/destination). By one approach, the network controller can be configured and arranged to simply comply with such instructions. By another approach, if desired, the network controller can be configured and arranged to take such instructions into account when making its own determination regarding allowing access to the wireless communications device.

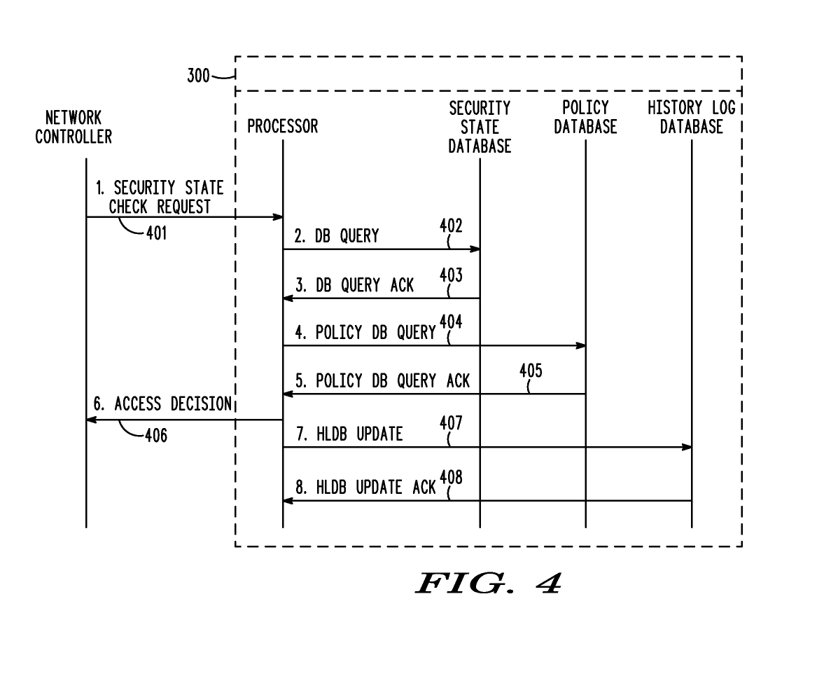

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative example, the facilitating mobile subscriber access control manager apparatus, which will be referred to herein as a security state server 300, comprises a processor 301 that operably couples to an Internet Protocol-based communications network interface 302. The latter can and will vary with the needs and/or requirements of a given application setting as will be well-understood by those skilled in the art. In general, this network interface 302 serves to communicatively couple the security state server 300 to an Internet Protocol network 303 of choice (such as a private intranet and/or a public extranet such as the well known Internet).

The processor 301 can comprise a programmable or dedicated purpose platform as are known in the art. By one approach this processor 301 is configured and arranged (via, for example, programming where appropriate) to carry out and effectuate one or more of the steps and functionality described herein. This can include, for example, making the aforementioned determination that a wireless communication device seeks access to a given Internet Protocol-based communication network, assessing the security state as corresponds to that wireless communication device, and informing the corresponding network controller (via the aforementioned Internet Protocol-based communications network interface 302) as to whether the wireless communications device should be granted such access to or via the Internet Protocol-based communication network as a function of that assessed security state for that wireless communications device.

If desired, and to aid in facilitating such activities, this security state server 300 can further optionally comprise a security state data base 304. This security state data base 304 can operably couple to the processor 301 and can, in turn, serve to retain and store the security state information for one or more wireless communications devices. For example, the processor 301 can be further configured and arranged to receive security state information as corresponds to a given wireless communications device and to then store such security state information in this security state data base 304. So provisioned, the processor 301 can then readily query the security state data base 304 to retrieve security state information as needed to make the described assessments.

In addition, and again if desired, this security state server 300 can also further optionally comprise a policy data base 305. This policy data base 305 can also operably couple to the processor 301 and can, in turn, serve to retain and store one or more policies as described above. So provisioned, the processor 301 can then readily query the policy data base 305 to retrieve one or more policies as correspond to assessed security state information to thereby aid in determining whether, and under what conditions, a given wireless communications device should be granted access to a given Internet Protocol-based communication network.

Also if desired, this security state server 300 can optionally include a history log data base 306 that also operably couples to the processor 301. This history log data base 306 can serve to retain historical information regarding, for example, previous security states for various wireless communications devices, previous decisions regarding whether to permit access for specific wireless communications devices, and so forth. Such information might serve to further facilitate the making of access decisions and/or to provide an audit trail or the like for administrative purposes and tracking.

Those skilled in the art will recognize and understand that such a security state server 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

Referring now to FIG. 4, an illustrative example of the operability of such a security state server 300 will be described. Those skilled in the art will recognize and understand that this example is intended to serve only in an illustrative capacity and is not intended to comprise an exhaustive listing of all possibilities in this regard.

In this example, a network controller transmits a security state check request 401 to the security state server 300. This can occur, for example, when the wireless communication device first seeks access to the wireless communications network (meaning, of course, that this check can take place at the very beginning of the mobile attachment process and activity. By this approach, for example, the security state check will precede other network authentication activities which may be preferable in many application settings. The above-described processor responds to this request by providing a data base (DB) query 402 to the security state data base to retrieve, by way of response, a data base query acknowledgement 403 that comprises the security state information as corresponds to the wireless communication device identified in the aforementioned security state check request 401. The processor uses this security state information to formulate a policy data base query 404 to which the policy data base responds with a corresponding policy data base query acknowledgement 405 that contains one or more relevant and applicable policies.

The processor then transmits the corresponding access decision 406 to the network controller. In this illustrative example, the processor also now forwards a history log data base update 409 to the history log data base that contains information of interest regarding this decision. The history log data base in turn returns a history log data base update acknowledgement 408 to the processor to complete the process.

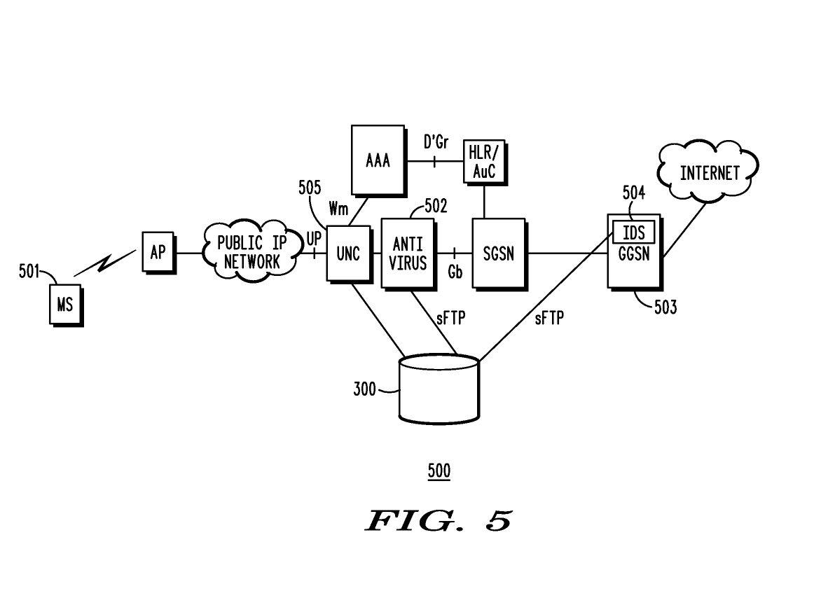

Referring now to FIG. 5, a more specific example of these teachings employed in a specific instantiated setting will be provided. Again, those skilled in the art will recognize that other possibilities exist in this regard as well with yet others likely to be developed going forward. Accordingly, the particulars of this example are not to be taken as expressions or acknowledgements of limitations with respect to the application of these teachings.

In this example, an Unlicensed Mobile Access (UMA) network 500 as is known in the art serves as an Internet Protocol-based communication network in providing corresponding wireless communications services to one or more wireless communications devices (comprised here of so-called mobile stations (MS)) 501. In this example, the UMA network 500 further comprises both an antivirus component 502 and a Gateway GPRS (which is an acronym for General Packet Radio Service) Support Node (GGSN) 503 having an integrated intrusion detection system (IDS) capability 504. Those skilled in the art will recognize and understand that such elements are well known are require no further elaboration here.

So configured, a security state server 300 as described herein can operably couple to, for example, the antivirus component 502 and the intrusion detection system 504 (using, for example, Secure File Transfer Protocol (sFTP) to facilitate communications therebetween) in order to obtain the security state information contemplated by these teachings. So provisioned, the security state server 300 can then further operably couple to a UMA network controller (UNC) 505 in order to advise the network controller 505 with respect to whether to permit a given wireless communications device 501 to access the UMA network 500 as a function of such security state information.

So configured, those skilled in the art will recognize and appreciate that these teachings provide a simple, effective, and powerful mechanism for aiding a given network to avoid problems that may be associated with permitting network access to a user platform that harbors potentially detrimental software that may be transmissible to that network. These teachings are compatible for use with other access-conditioning processes such as ordinary accounting, authentication, and authorization activities. These teachings are also readily applied, for the most part, with little or no modification to existing infrastructure elements of fielded systems thereby making these teachings suitable for use in retrofitting application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
determining that a wireless communications device seeks access to an Internet Protocol-based communications network;
assessing a security state as corresponds to the wireless communications device;
informing a network controller for the Internet Protocol-based communications network as to whether the wireless communications device should be granted the access to the Internet Protocol-based communications network as a function of the security state as corresponds to the wireless communications device.

2. The method of claim 1 wherein determining that a wireless communications device seeks access to an Internet Protocol-based communications network comprises, at least in part, receiving a security state check request from the network controller for the Internet Protocol-based communications network.

3. The method of claim 1 wherein assessing a security state comprises, at least in part, querying a security state data base to retrieve security state information as correlates to the wireless communications device.

4. The method of claim 3 wherein assessing a security state further comprises, at least in part, querying a policy data base to retrieve a policy as corresponds to the security state information.

5. The method of claim 4 wherein informing a network controller for the Internet Protocol-based communications network as to whether the wireless communications device should be granted the access to the Internet Protocol-based communications network as a function of the security state as corresponds to the wireless communications device further comprises informing the network controller for the Internet Protocol-based communications network as to whether the wireless communications device should be granted the access to the Internet Protocol-based communications network as a function of the policy as corresponds to the security state information.

6. The method of claim 1 further comprising:
receiving information as corresponds to at least one security state of the wireless communications device;
storing security state information as corresponds to the information in a security state data base.

7. The method of claim 6 wherein receiving security state information as corresponds to the wireless communications device comprises, at least in part, receiving the security state information from a network monitoring platform.

8. The method of claim 7 wherein the network monitoring platform comprises at least one of:
an intrusion detection system;
an intrusion detection and prevention system;
a firewall;
an application proxy server;
a virus detection system.

9. The method of claim 1 wherein informing a network controller for the Internet Protocol-based communications network as to whether the wireless communications device should be granted the access to the Internet Protocol-based communications network as a function of the security state as corresponds to the wireless communications device further comprises determining whether to:
deny the access to the Internet Protocol-based communications network;
permit unrestricted access to the Internet Protocol-based communications network;
permit only conditional access to the Internet Protocol-based communications network.

10. The method of claim 9 wherein the conditional access comprises at least one of:
time-limited access;
functionally-limited access;
services-limited access;
destination-limited access.

11. An apparatus comprising:
an Internet Protocol-based communications network interface;
a processor operably coupled to the Internet Protocol-based communications network interface and being configured and arranged to:
determine that a wireless communications device seeks access to the Internet Protocol-based communications network;
assess a security state as corresponds to the wireless communications device;
inform a network controller for the Internet Protocol-based communications network, via the Internet Protocol-based communications network interface, as to whether the wireless communications device should be granted the access to the Internet Protocol-based communications network as a function of the security state as corresponds to the wireless communications device.

12. The apparatus of claim 11 wherein the processor is further configured and arranged to determine that a wireless communications device seeks access to an Internet Protocol-based communications network by, at least in part, receiving a security state check request from the network controller for the Internet Protocol-based communications network.

13. The apparatus of claim 11 further comprising:
a security state data base;
and wherein the processor is further configured and arranged to assess a security state by, at least in part, querying the security state data base to retrieve security state information as correlates to the wireless communications device.

14. The apparatus of claim 13 further comprising:
a policy data base;
and wherein the processor is further configured and arranged to assess a security state further by, at least in part, querying the policy data base to retrieve a policy as corresponds to the security state information.

15. The apparatus of claim 14 wherein the processor is further configured and arranged to inform the network controller for the Internet Protocol-based communications network as to whether the wireless communications device should be granted the access to the Internet Protocol-based communications network as a function of the security state as corresponds to the wireless communications device by informing the network controller for the Internet Protocol-based communications network as to whether the wireless communications device should be granted the access to the Internet Protocol-based communications network as a function of the policy as corresponds to the security state information.

16. The apparatus of claim 13 wherein the processor is further configured and arranged to:
receive security state information as corresponds to the wireless communications device;
store the security state information in the security state data base.

17. The apparatus of claim 16 wherein the processor is further configured and arranged to receive security state information as corresponds to the wireless communications device by, at least in part, receiving the security state information from a network monitoring platform.

18. The apparatus of claim 11 wherein the processor is further configured and arranged to inform the network controller for the Internet Protocol-based communications network as to whether the wireless communications device should be granted the access to the Internet Protocol-based communications network as a function of the security state as corresponds to the wireless communications device by determining whether to:
deny the access to the Internet Protocol-based communications network;
permit unrestricted access to the Internet Protocol-based communications network;
permit only conditional access to the Internet Protocol-based communications network.

19. The apparatus of claim 18 wherein the conditional access comprises at least one of:
time-limited access;
functionally-limited access;
services-limited access;
destination-limited access.
